(19) United States
(12) Patent Application Publication
(10) Pub. No.: US 2014/0215266 A1
(43) Pub. Date: Jul. 31, 2014

(54) DATA RECOVERY SYSTEM AND STORAGE MEDIUM WITH RECOVERY FUNCTION AND DATA RECOVERY METHOD

(71) Applicants: Hon Hai Precision Industry Co., Ltd., New Taipei (TW); Hong Fu Jin Precision Industry (ShenZhen) Co., Ltd., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/148,538

(22) Filed: Jan. 6, 2014

(30) Foreign Application Priority Data
Jan. 25, 2013 (CN) 201310028536X

(51) Int. Cl. G06F 11/14

(52) U.S. Cl. CPC G06F 11/1412
USPC 714/15

(57) ABSTRACT

A data recovery system for recovering at least one system parameter of an electronic device. The electronic device comprises a first storage module for storing a check parameter and the system parameter, and a second storage module for storing a first default value corresponding to the check parameter and at least one second default value corresponding to the system parameter. The data recovery system comprises an obtaining module for obtaining a check parameter when the electronic device starts up, a determining module for determining whether the check parameter matches the first default value, and a recovery module for recovering the system parameter to a second default value when the check parameter is not the first default value. A storage medium with a recovery function and a data recovery method applied in the data recovery system are also disclosed.

### BACKGROUND

1. Technical Field

The present disclosure relates to data recovery systems and methods, and more particularly to a data recovery system and method capable of recovering an initial value of a system parameter when the system parameter is in error.

2. Description of Related Art

Embedded systems, such as those in an electronic device, may obtain a system parameter from a storage medium of the electronic device for controlling the electronic device, and rewrites data to the storage medium in response to user input for setting the electronic device. However, the data may be rewritten in error during the setting process because of hardware deficiencies or voltage instability. As a result, the electronic device may be unable to work properly because of the rewritten data having errors.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a data recovery system.

FIG. 2 is a flowchart of an embodiment of a data recovery method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

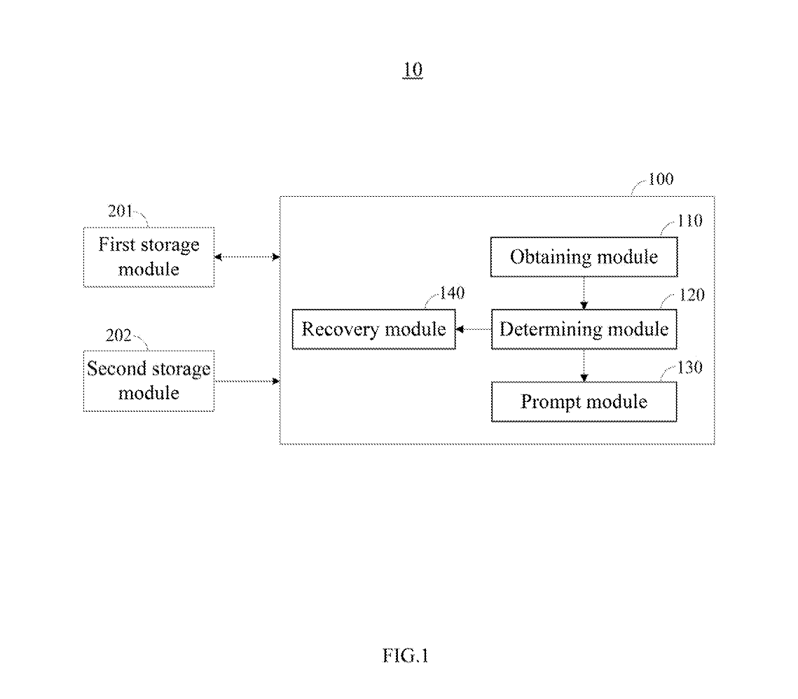

FIG. 1 shows a block diagram of an embodiment of a data recovery system 100. The data recovery system 100 is capable of recovering system parameters of an electronic device 10 when the system parameters are in error to prevent the electronic device 10 from malfunctioning. The data recovery system 100 is contained in an electronic device 10. The electronic device 10 can be a computer, a portable DVD player, a set-top box, or the like. The electronic device of the present embodiment is a portable DVD player.

The electronic device 10 comprises a first storage module 201, which comprises a check parameter and at least one system parameter, and a second storage module 202, which comprises a first default value corresponding to the check parameter and at least one second default value corresponding to the system parameter. In this embodiment, the first default value and the second default value are stored in the electronic device during manufacturing. In this embodiment, the first storage module 201 and the second storage module 202 can be Electrically Erasable Programmable Read-Only Memory (EEPROM). The system parameter and the check parameter stored in the first storage 201 are invoked by the electronic device 10 for realizing some functions and can be changed. In detail, the system parameter and the check parameter are stored in different areas of the first storage 201. Thus, when the system parameter is changed, the check parameter will not be changed. In detail, the check parameter is stored at the beginning of the first storage module 201. If an operation to change the system parameter (hereinafter “the change operation”) is mistakenly identified as an operation to clear data (hereinafter “the clear operation”), the check parameter may be cleared. Furthermore, if the first storage 201 is cleared from the beginning by the clear operation, the electronic device 10 is able to restore the first storage 201 according to the second storage module 202. In this embodiment, the check parameter is “SX79” and stored in the first four byte of the first storage 201.

The data recovery system 100 comprises an obtaining module 110, a determining module 120, a prompt module 130, and a recovery module 140.

The obtaining module 110 obtains the check parameter from the first storage 201 when the electronic device 10 starts up.

The determining module 120 determines whether the check parameter matches the first default value. If the check parameter does not match the first default value, the determining module 120 generates a prompt instruction and a recovery instruction. If the check parameter matches the first default value, the determining module 120 generates a start-up instruction for controlling the electronic device 10 to start up.

The prompt module 130 generates a warning message for informing the user that the system parameter is wrong in response to the prompt instruction. The warning message can be characters displayed on a display (not shown). In another embodiment, the warning message is an audio message outputted by a speaker (not shown).

The recovery module 140 recovers the system parameter with the second default value in response to the recovery instruction and generates a start-up instruction for controlling the electronic device 10 to start up. In detail, the recovery module 140 clears data in the first storage 201 and recovers the system parameter with the second default value stored in the second storage 202. Thus, the recovery module 140 protects the electronic device 20 from malfunctioning due to error of the system parameter. In another embodiment, the recovery module 140 further recovers the check parameter with the first default value stored the second storage 202.

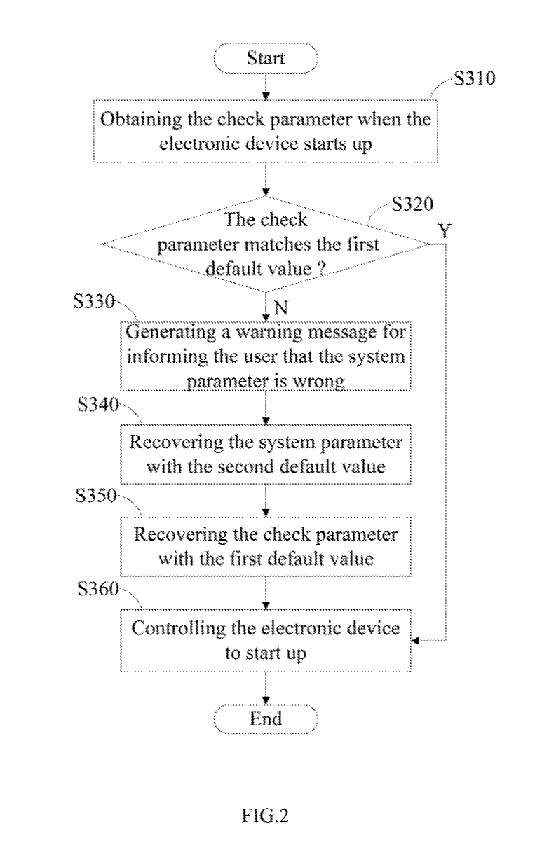

Referring to FIG. 2, a data recovery method for recovering system parameters of an electronic device 10 is provided. The method is applied in the data recovery system 100, which is contained in the electronic device 10. The method comprises the following steps:

In step S310, the obtaining module 110 obtains the check parameter from the first storage module 201 when the electronic device 10 starts up.

In step S320, the determining module 120 determines whether the check parameter matches the first default value. If the check parameter does not match the first default value, step S330 is implemented. If the check parameter matches the first default value, step S360 is implemented.

In step S330, the prompt module 130 generates a warning message for informing the user that the system parameter is wrong. The warning message can be characters displayed on the display. In another embodiment, the warning message can be an audio message outputted by a speaker.

In step S340, the recovery module 140 recovers the system parameter with the second default value in response to the recovery instruction. In detail, the recovery module 140 clears the data in the first storage module 201 and sets the system parameter to the second default value according to the second storage module 202, thereby recovering the system parameter. Thus, the recovery module 140 protects the electronic device 20 from malfunctioning due to error of the system parameter.

In step S350, the recovery module 140 recovers the check parameter from the first storage module 201 with the first default value according to the second storage module 202.

In step S360, the recovery module 140 generates a start-up instruction for controlling the electronic device 10 to start up.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A data recovery system for recovering at least one system parameter of an electronic device, the electronic device comprising a first storage module for storing a check parameter and the system parameter, and a second storage module for storing a first default value corresponding to the check parameter and at least one second default value corresponding to the system parameter, the data recovery system comprising:
an obtaining module for obtaining the check parameter when the electronic device starts up;
a determining module determining whether the check parameter matches the first default value; and
a recovery module for recovering the system parameter with the second default value when the check parameter does not match the first default value.

2. The data recovery system as claimed in claim 1, wherein the recovery module is further used for recovering the check parameter with the first default value when the check parameter does not match the first default value.

3. The data recovery system as claimed in claim 1, wherein the recovery module is further used for controlling the electronic device to start up when the check parameter matches the first default value.

4. The data recovery system as claimed in claim 1, further comprises a prompt module for generating a warning message for informing the user that the system parameter is error.

5. The data recovery system as claimed in claim 1, wherein the check parameter is stored at the beginning of the first storage module.

6. The data recovery system as claimed in claim 1, wherein the first default value and the second default value are stored in the electronic device during manufacture.

7. A data recovering method applied in a data recovery system for recovering at least one system parameter of an electronic device, the electronic device comprising a storage module for storing a check parameter and the system parameter, and a second storage module for storing a first default value corresponding to the check parameter and at least one second default value corresponding to the system parameter, the data method comprising:
obtaining the check parameter when the electronic device starts up;
determining whether the check parameter matches the first default value; and
recovering the system parameter with the second default value when the check parameter does not match the first default value.

8. The data recovery method as claimed in claim 7, further comprising:
recovering the check parameter with the first default value when the check parameter does not match the first default value.

9. The data recovery method as claimed in claim 7, further comprising:
controlling the electronic device to start up when the check parameter matches the first default value.

10. The data recovery method as claimed in claim 7, further comprising:
generating a warning message for informing the user that the system parameter is error.

11. The data recovery method as claimed in claim 7, wherein the check parameter is stored at the beginning of the first storage module.

12. The data recovery method as claimed in claim 7, wherein the first default value and the second default value are stored in the electronic device during manufacture.

13. A non-transitory storage medium storing a plurality of modules, the plurality of modules comprising instructions executable by a processor of an electronic device to perform a data recovery method for recovering at least one system parameter of the electronic device, the electronic device comprising a storage module for storing a check parameter and the system parameter, and a second storage module for storing a first default value corresponding to the check parameter and at least one second default value corresponding to the system parameter, the data recovery method comprising:
obtaining a check parameter when the electronic device starts up;
determining whether the check parameter matches the first default value; and
recovering the system parameter to the second default value when the check parameter does not match the first default value.

14. The non-transitory storage medium as claimed in claim 13, wherein the data recovery method further comprising:
recovering the check parameter to the first default value when the check parameter does not match the first default value.

15. The non-transitory storage medium as claimed in claim 13, wherein the data recovery method further comprising:
controlling the electronic device to start up when the check parameter matches the first default value.

16. The non-transitory storage medium as claimed in claim 13, wherein the data recovery method further comprising:
generating a warning message for informing the user that the system parameter is error.

17. The non-transitory storage medium as claimed in claim 13, wherein the check parameter is stored at the beginning of the first storage module.

18. The non-transitory storage medium as claimed in claim 13, wherein the first default value and the second default value are stored in the electronic device during manufacture.
